(19) United States
(12) Patent Application Publication
(10) Pub. No.: US 2016/0146680 A1
(43) Pub. Date: May 26, 2016

(54) PRESSURE SENSOR USING PIEZOELECTRIC BENDING RESONATORS

(71) Applicant: CALIFORNIA INSTITUTE OF TECHNOLOGY, Pasadena, CA (US)

(72) Inventors: Xiaoqi Bao, San Gabriel, CA (US); Stewart Sherrit, La Crescenta, CA (US)

(21) Appl. No.: 14/948,184

(22) Filed: Nov. 20, 2015

Related U.S. Application Data
(60) Provisional application No. 62/082,983, filed on Nov. 21, 2014.

(51) Int. Cl. G01L 1/16; E21B 47/06

(52) U.S. Cl. CPC G01L 1/167; E21B 47/06

(57) ABSTRACT

A pressure sensor including an enclosure and a bending resonator housed in the enclosure. The bending resonator includes a diaphragm connected to the enclosure, a piezoelectric layer on the diaphragm, and an electrode on the piezoelectric layer. The pressure sensor also includes an electrical terminal coupled to the piezoelectric layer and extending out through the enclosure. The electrical terminal applies an input signal to the piezoelectric layer to resonate the bending resonator. A resonance frequency of the bending resonator changes according to a change in an external pressure applied to the pressure sensor and the resonance frequency of the bending resonator corresponds to the external pressure applied to the pressure sensor.

### CROSS-REFERENCE TO RELATED APPLICATIONS

This application claims priority to and the benefit of U.S. Provisional Application No. 62/082,983, filed Nov. 21, 2014, the entire content of which is incorporated herein by reference.

### FIELD

The present disclosure is directed to pressure sensors in general and, more particularly, to pressure sensors including a piezoelectric bending resonator.

### BACKGROUND

A variety of different types of pressure sensors exist, including potentiometric pressure sensors, inductive pressure sensors, capacitive pressure sensors, piezoelectric pressure sensors, and strain gauge pressure sensors. The type of pressure sensor may be selected based on its suitability for the environment in which the pressure measurements will be performed and/or the desired performance characteristics of the pressure sensor.

However, there are a variety of limitations associated with conventional pressure sensors, including vibration sensitivity and/or thermal sensitivity. Additionally, some conventional pressure sensors must be large to produce a usable pressure reading, which limits the suitability of these sensors for some applications. Some conventional pressure sensors are limited to measuring dynamic pressure changes rather than static pressure measurements. Furthermore, many conventional pressure sensors require an external power supply, which renders these pressure sensors undesirable or unsuitable for particular applications, such as measuring the downhole pressure of an oil well.

### SUMMARY

The present disclosure is directed to various embodiments of a pressure sensor. In one embodiment, the pressure sensor includes an enclosure defining an interior cavity and a bending resonator housed in the interior cavity. The bending resonator includes a diaphragm connected to the enclosure, at least one piezoelectric layer on a first surface or a second surface of the diaphragm, and at least one electrode on the at least one piezoelectric layer. The pressure sensor also includes at least one electrical terminal coupled to the at least one piezoelectric layer and extending out through the enclosure. The at least one electrical terminal is configured to apply an input signal to the at least one piezoelectric layer to resonate the bending resonator. A resonance frequency of the bending resonator changes according to a change in an external pressure applied to the pressure sensor, and the resonance frequency of the bending resonator corresponds to the external pressure applied to the pressure sensor.

The enclosure may be configured to deform when the external pressure is applied to the pressure sensor. Deformation of the enclosure may apply tension or compression to the bending resonator to change the resonance frequency of the bending resonator.

The at least one piezoelectric layer may include a first piezoelectric layer on the first surface of the diaphragm and a second piezoelectric layer on the second surface of the diaphragm. The first piezoelectric layer may be coupled to the first piezoelectric layer. The first piezoelectric layer may be coupled to the second piezoelectric layer in parallel or in series. The at least one piezoelectric layer may include a series of piezoelectric layers on the first surface or the second surface of the diaphragm. The at least one piezoelectric layer may include a series of stacked piezoelectric layers. The at least one piezoelectric layer may include any suitable polarized material, such as a piezoceramic material (e.g., lead zirconate titanate (PZT) or barium titanate), an electrostrictive material, or a piezoelectric crystal (e.g. quartz). The at least one electrode may include a series of electrodes patterned on the at least one piezoelectric layer.

The enclosure may have any suitable shape, such as a cylindrical shape, a spherical shape, or a prismatic shape. The enclosure may be a flextensional enclosure. The enclosure may include at least one sidewall, a base connected to a first end of the at least one sidewall, and a cap connected to a second end of the at least one sidewall opposite the first end. The bending resonator may have any suitable shape, such as a circular shape, a square shape, a ring shape, or a rectangular shape. A thickness of the bending resonator may be uniform or non-uniform.

The present disclosure is also directed to various methods of measuring pressure. In one embodiment, the method includes positioning a pressure sensor in an environment exhibiting the pressure to be measured. The pressure sensor includes an enclosure defining an interior cavity and a bending resonator housed in the interior cavity. The bending resonator includes a diaphragm connected to the enclosure, at least one piezoelectric layer on a first surface or a second surface of the diaphragm, and at least one electrode on the at least one piezoelectric layer. The pressure sensor also includes at least one electrical terminal coupled to the at least one piezoelectric layer and extending out through the enclosure. A resonance frequency of the bending resonator changes according to a change in the pressure of the environment and the resonance frequency of the bending resonator corresponds to the pressure of the environment. The method also includes applying an input signal to the at least one piezoelectric layer to resonate the bending resonator, determining the resonance frequency of the bending resonator, and determining the pressure of the environment by referencing the resonance frequency of the bending resonator. The pressure of the environment deforms the enclosure and deformation of the enclosure applies tension or compression on the bending resonator and varies the resonance frequency of the bending resonator. The method may include reading the resonance frequency of the bending resonator through an electromagnetic waveguide.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale, nor is every feature in the drawings necessarily required to fall within the scope of the described invention.

FIG. 1A is a cross-sectional view of a pressure sensor including a resonator according to one embodiment of the present disclosure;

FIG. 1B is a cross-sectional view of the embodiment of the pressure sensor illustrated in FIG. 1A when deformed under an external pressure;

FIG. 2 is a graph of electrical impedance versus frequency of the resonator of the pressure sensor according to one embodiment of the present disclosure;

FIG. 3 is a graph depicting the resonance frequency of the resonator as a function of the thickness of the resonator when the pressure sensor is unstressed and when the pressure sensor is subjected to an external pressure of 100 MPa;

FIG. 4 is a graph depicting the change of resonance frequency of the resonator as a function of the thickness of the piezoelectric layer when the pressure sensor is subjected to an external pressure change of 100 MPa;

FIG. 5 is a graph depicting the minimum electrical impedance of the resonator as a function of the thickness of the piezoelectric layer for a resonator having a composite quality factor (Q) of 500 and for a resonator having a titanium diaphragm, a piezoelectric layer, and epoxy with quality factors (Q) of 1000, 500, and 10, respectively;

FIG. 6 is a cross-sectional view of a pressure sensor including a resonator according to another embodiment of the present disclosure; and

FIGS. 7A-7B are a cross-sectional view and an enlarged sectional view, respectively, of a pressure sensor including a resonator according to a further embodiment of the present disclosure.

### DETAILED DESCRIPTION

The present disclosure is directed to various embodiments of a pressure sensor having a piezoelectric bending resonator housed in an enclosure. When an external pressure or force is applied to the pressure sensor, the enclosure deforms and induces tension or compression on the resonator depending on the configuration of the enclosure and/or the resonator. The tension or compression induced on the resonator changes the resonance frequency of the resonator, and the change in the resonance frequency of the resonator due to the tension or compression on the resonator corresponds the external pressure acting on the pressure sensor. The pressure sensor may be calibrated and a resonance frequency spectrum of the resonator may be mapped to a pressure spectrum of the external pressure acting on the pressure sensor. Accordingly, the resonance frequency of the resonator may be used to determine the corresponding external pressure or force acting on the pressure sensor.

The pressure sensors of the present disclosure may be suitable for use in a variety of pressure measurement applications, such as, for instance, in the oil industry (e.g., measuring the downhole pressure of an oil well) and/or in aeronautical and space operations (e.g., measuring planetary atmospheric pressure and/or oceanic pressure). For instance, the pressure sensors of the present disclosure may be used as a passive downhole high-pressure sensor that is readable remotely from the surface using an electromagnetic waveguide system (e.g., concentric pipes downhole functioning as an electromagnetic waveguide). Accordingly, the pressure sensors of the present disclosure may be passive devices with no electric power supply and remotely readable through an electromagnetic waveguide.

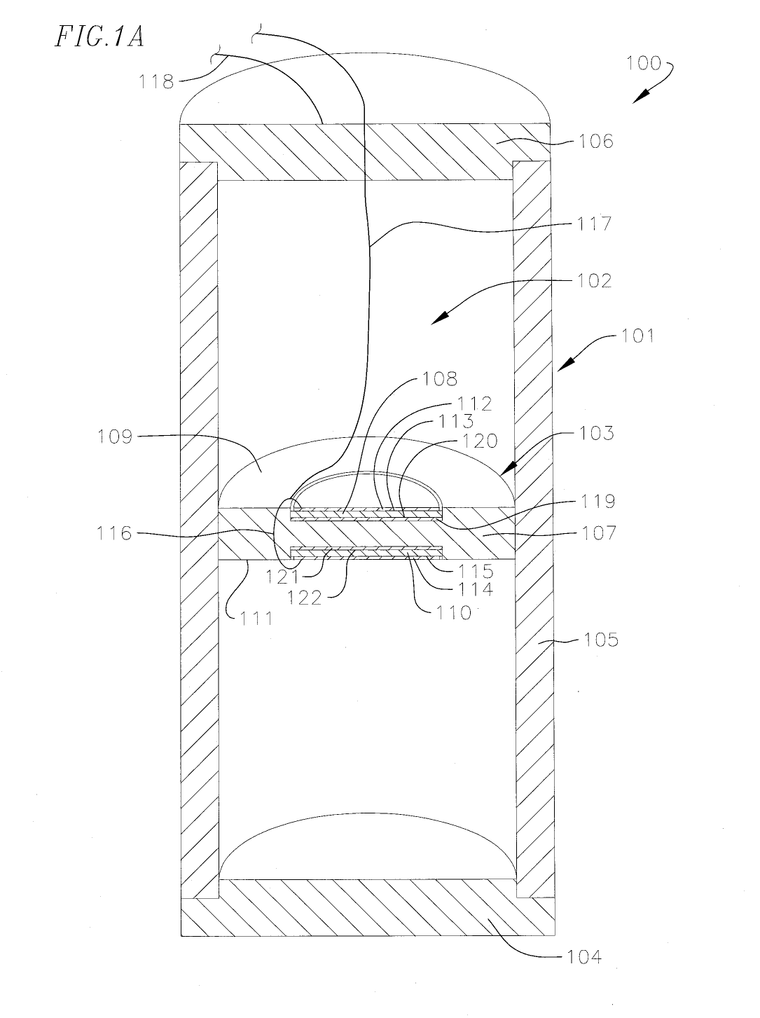

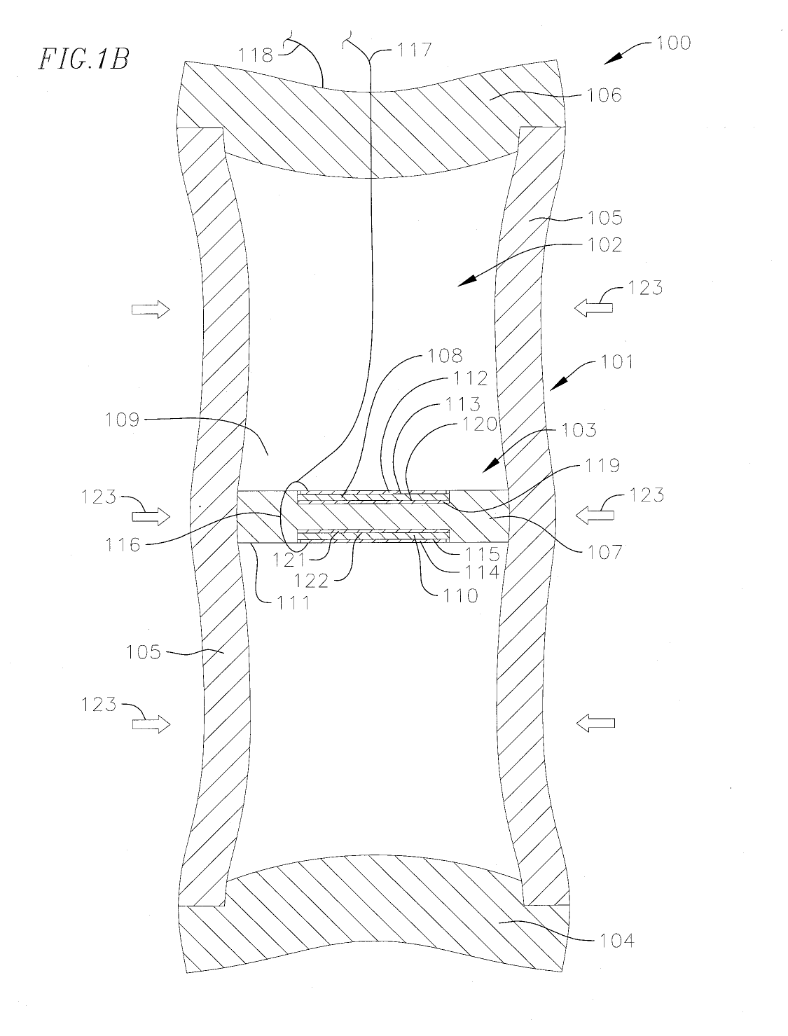

With reference now to FIG. 1A, a pressure sensor 100 according to one embodiment of the present disclosure includes a vessel or enclosure 101 defining a sealed interior cavity or chamber 102 and a resonator 103 housed in the interior cavity 102 and connected to the enclosure 101. In the illustrated embodiment, the enclosure 101 includes a base 104, at least one sidewall 105, and a cap 106. The base 104 and the cap 106 are connected to opposite ends of the at least one sidewall 105. The base 104 and the cap 106 may be coupled to the sidewall 105 by any suitable manufacturing process or technique, such as, for instance, bonding with epoxy, welding, and/or brazing. Additionally, in the illustrated embodiment, the enclosure 101 is cylindrical (e.g., the base 104 and the cap 106 are circular and the enclosure 101 includes a single cylindrical sidewall 105 extending between the base 104 and the cap 106). In one or more embodiments, the enclosure may have any other suitable shape, such as, for instance, a prismatic shape (e.g., a square prismatic shape) or any other suitable non-prismatic shape (e.g., spherical). Accordingly, although in the illustrated embodiment the enclosure 101 includes a single sidewall 105, in one or more embodiments the enclosure 101 may have any other suitable number of sidewalls 105 depending on the desired shape of the enclosure 101. Additionally, the enclosure 101 may have any size suitable for the intended application of the pressure sensor 100. For instance, in one or more embodiments, the enclosure 101 may have a diameter from approximately 10 mm (approximately 0.4 in) to approximately 40 mm (approximately 1.6 in) and a height from approximately 20 mm (approximately 0.8 in) to approximately 100 mm (approximately 3.9 in). In one or more embodiments, the diameter of the enclosure 101 may be approximately 25 mm (approximately 1.0 in) and the height of the enclosure 101 may be approximately 60 mm (approximately 2.4 in).

With continued reference to the embodiment illustrated in FIG. 1A, the resonator 103 is housed in the sealed interior cavity 102 of the enclosure 101. The resonator 103 is configured to resonate (e.g., vibrate or oscillate) in the interior cavity 102 of the enclosure 101 and the resonance frequency of the resonator 103 varies according to the external force or pressure applied to the enclosure 101, the significance of which is described below. In the illustrated embodiment, the resonator 103 includes a diaphragm 107 connected to the sidewall 105 (e.g., the diaphragm 107 extends radially inward from the sidewall 105). Although in the illustrated embodiment the diaphragm 107 is axially centered along the length of the sidewall 105, in one or more embodiments, the diaphragm 107 may be positioned at any other suitable position along the length of the sidewall 105 (e.g., the diaphragm 107 may be proximate the base 104 or the cap 106 of the enclosure 101). The diaphragm 107 may have any suitable shape depending, for instance, on the shape of the enclosure 101. For instance, in one or more embodiments, the diaphragm 107 may be a circular plate, a square plate, or a rectangular plate. In one or more embodiments, the diaphragm 107 may be a beam. Although in the illustrated embodiment the diaphragm 107 is connected to the sidewall 105 of the enclosure 101 entirely along an outer periphery of the diaphragm 107, in one or more embodiments, the diaphragm 107 may not be connected to the sidewall 105 entirely along the outer periphery of the diaphragm 107. In the illustrated embodiment, the diaphragm 107 is integral with the sidewall 105 of the enclosure 101. In one or more embodiments, the diaphragm 107 may be separately formed from the sidewall 105 and coupled to the sidewall 105 of the enclosure 101 by any suitable technique, such as, for instance, by mechanically coupling the diaphragm 107 to the sidewall 105 of the enclosure 101. The diaphragm 107 may be made out of any suitable material, such as, for instance, titanium.

In the illustrated embodiment, the resonator 103 also includes a first piezoelectric layer 108 on a first surface 109 (e.g., an upper surface) of the diaphragm 107, a second piezoelectric layer 110 on a second surface 111 (e.g., a lower surface) of the diaphragm 107, at least one electrode 112 on an outer surface 113 of the first piezoelectric layer 108, and at least one electrode 114 on an outer surface 115 of the second piezoelectric layer 110. The first piezoelectric layer 108 may cover all or substantially all of the first surface 109 of the diaphragm 107 or the first piezoelectric layer 108 may cover only a portion or portions of the first surface 109 of the diaphragm 107. The second piezoelectric layer 110 may cover all or substantially all of the second surface 111 of the diaphragm 107 or the second piezoelectric layer 110 may cover only a portion or portions of the second surface 111 of the diaphragm 107. In the illustrated embodiment, the first piezoelectric layer 108 is poled in the same direction as the second piezoelectric layer 110. The first and second piezoelectric layers 108, 110 may be made out of any suitable polarized material, such as, for instance, a piezoceramic material (e.g., lead zirconate titanate (PZT) or barium titanate), a electrostrictive material, or a piezoelectric crystal (e.g. quartz). In one or more embodiments, the first and second piezoelectric layers 108, 110 may be piezoceramic PZT-8. Additionally, in the illustrated embodiment, the pressure sensor 100 includes an electrical line 116 coupling the one or more electrodes 112 on the first piezoelectric layer 108 to the one or more electrodes 114 on the second piezoelectric layer 110 (e.g., the electrical line 116 extends from the one or more electrodes 112 on the first piezoelectric layer 108, through the diaphragm 107, and to the one or more electrodes 114 on the second piezoelectric layer 110). In the illustrated embodiment, the pressure sensor 100 also includes a first electrical terminal 117 coupled to the electrical line 116 that couples the one or more electrodes 112 on the first piezoelectric layer 108 to the one or more electrodes 114 on the second piezoelectric layer 110. In the illustrated embodiment, the first electrical terminal 117 extends up and out of the sealed interior cavity 102 through the cap 106. In the illustrated embodiment, the pressure sensor 100 also includes a second electrical terminal 118 coupled to the enclosure 101 (e.g., the cap 106 or the base 104 of the enclosure 101). The second electrical terminal 118 is configured to function as a grounding terminal for grounding the enclosure 101. In one or more embodiments, the enclosure 101 may include a feedthrough on the cap 106 to enable the first electrical terminal 117 to pass through the cap 106.

Although in the illustrated embodiment the resonator 103 has a uniform or substantially uniform thickness, in one or more embodiments, the resonator 103 may have a non-uniform thickness. For instance, in the illustrated embodiment, the piezoelectric layers 108, 110 are recessed in recesses or depressions in the surfaces 109, 111 of the diaphragm 107 such that outer surfaces the electrodes 112, 114 on the piezoelectric layers 108, 110 are flush or substantially flush with the outer surfaces 109, 111 of the diaphragm 107 and the resonator 103 has a uniform or substantially uniform thickness. In one or more embodiments, the piezoelectric layers 108, 110 may not be recessed in the diaphragm 107 (e.g., the piezoelectric layers 108, 110 may project outward from the outer surfaces 109, 111 of the diaphragm 107 such that the resonator 103 has a non-uniform thickness).

Although in the embodiment of the pressure sensor 100 illustrated in FIG. 1A the resonator 103 includes two piezoelectric layers 108, 110, in one or more embodiments the resonator 103 may include any other suitable number of piezoelectric layers. For instance, in one or more embodiments, the resonator 103 may include two or more piezoelectric layers on the first surface 109 and/or two or more piezoelectric layers on the second surface 111 of the diaphragm 107. In one or more embodiments, the resonator 103 may include two or more piezoelectric layers stacked on the first surface 109 and/or the second surface 111 of the diaphragm 107 (e.g., the resonator 103 may include one or more piezoelectric stacks). Stacking the piezoelectric layers may increase the capacitance of the resonator 103 and decrease the baseline (i.e., off-resonance) electrical impedance of the resonator 103 compared to a resonator having a single piezoelectric layer. In one or more embodiments, the resonator 103 may include only a single piezoelectric layer (i.e., a single piezoelectric layer on either the first surface 109 or the second surface 111 of the diaphragm 107).

Additionally, in the illustrated embodiment, the resonator 103 includes a grounding electrode 119 on an inner surface 120 of the first piezoelectric layer 108 and a grounding electrode 121 on an inner surface 122 of the second piezoelectric layer 110. The grounding electrodes 119, 121 are connected to the diaphragm 107 to ground the first and second piezoelectric layers 108, 110 to the diaphragm 107 and the enclosure 101.

In operation, when an external force or pressure is applied to the enclosure 101, the enclosure 101 deforms. For instance, in the embodiment of the pressure sensor 100 illustrated in FIG. 1B, portions of the sidewall 105 above and below the resonator 103 may bend or deflect inward such that a portion of the sidewall 105 at the resonator 103 bulges outward relative to the inwardly deflected portions when an external force or pressure (arrows 123) is applied to the enclosure 101. This deformation of the enclosure 101 induces tension on the resonator 103. The tension on the resonator 103 changes the resonance frequency of the resonator 103 (i.e., the resonance frequency of the resonator 103 varies according to the external pressure or force applied to the enclosure 101). In one or more alternate embodiments, the enclosure 101 and/or the resonator 103 may be configured such that the deformation of the enclosure 101 due to the external force or pressure (arrows 123) induces compression on the resonator 103. The change or shift in the resonance frequency of the resonator 103 due to the compression or tension on the resonator 103 may be correlated to (or associated with) the external pressure acting on the enclosure 101 of the pressure sensor 100. For instance, in one or more embodiments, the pressure sensor 100 may be calibrated and a resonance frequency spectrum of the resonator 103 may be mapped to a pressure spectrum of the pressure (arrows 123) acting on the pressure sensor 100 (e.g., in a lookup table). In this manner, the value of the external pressure (arrows 123) acting on the pressure sensor 100 may be obtained by determining the resonance frequency of the resonator 103 and referencing the lookup table to determine the corresponding pressure (arrows 123) acting on the pressure sensor 100.

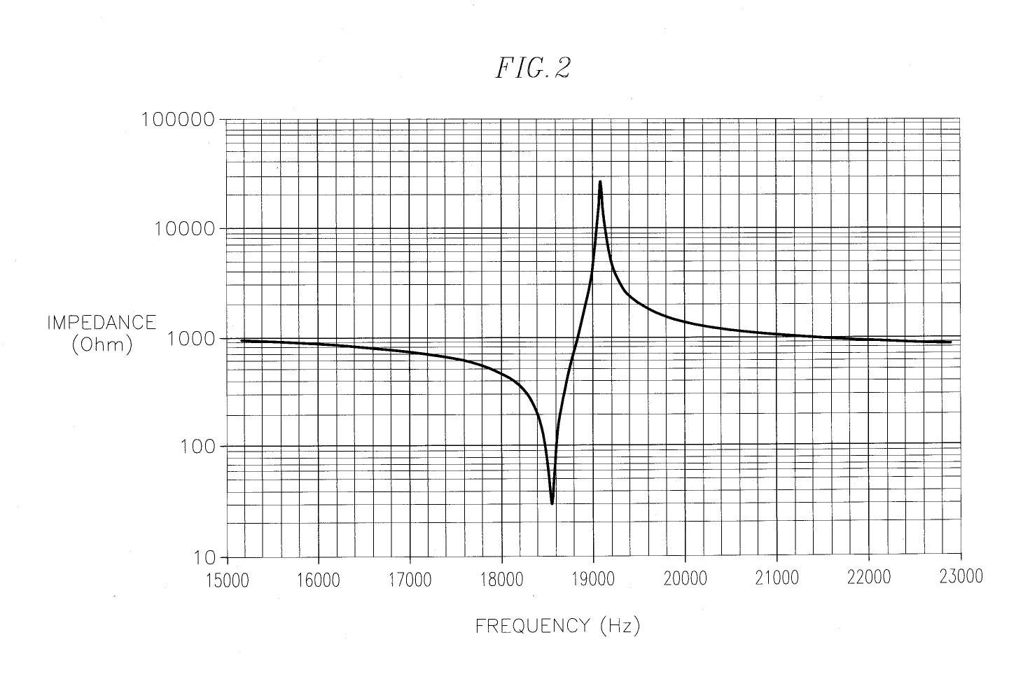

The resonance frequency of the resonator 103 may be determined by applying an input signal (e.g., an alternating current (AC) electric field) from the electrical terminals 117, 118 to the resonator 103 over a frequency range. The application of the AC electric field to the resonator 103 causes the piezoelectric layers 108, 110 to mechanically deform (e.g., vibrate) due to the inverse piezoelectric effect, which causes the resonator 103 to resonate at a frequency inside the interior cavity 102 of the enclosure 101. Additionally, as the frequency of the AC electric field is varied, the frequency at which the resonator 103 is vibrating and the electrical impedance of the resonator 103 vary. The resonance frequency of the resonator 103 corresponds to the minimum electrical impedance of the resonator 103. Accordingly, the resonance frequency of the resonator 103 may be determined by varying the frequency of the AC electric field applied to the resonator 103 and determining the frequency corresponding to the minimum electrical impedance of the resonator 103 (i.e., the minimum impedance frequency is the resonance frequency). FIG. 2 is a graph illustrating the electrical impedance of a resonator as a function of the frequency of the resonator according to one embodiment of the pressure sensor. In the illustrated embodiment, the resonator has a minimum impedance of approximately 30 Ohm at a resonance frequency of the resonator of approximately 18.5 kHz (i.e., at the resonance frequency of the resonator, the electrical impedance of the resonator drops to a minimum of approximately 18.5 kHz). In one or more embodiments, the resonator 103 may be configured to have a minimum electrical impedance at resonance frequency of less than approximately 50 Ohm. In one or more embodiments, the minimum electrical impedance of the resonator 103 may be correlated to (or associated with) the external pressure applied to the enclosure 101 of the pressure sensor 100. For instance, in one or more embodiments, a minimum electrical impedance spectrum of the resonator 103 may be mapped to a pressure spectrum of the pressure (arrows 123) acting on the pressure sensor 100 (e.g., in a lookup table). In this manner, the value of the external pressure (arrows 123) acting on the pressure sensor 100 may be obtained by determining the minimum electrical impedance of the resonator 103 and referencing the lookup table to determine the corresponding pressure (arrows 123) acting on the pressure sensor 100.

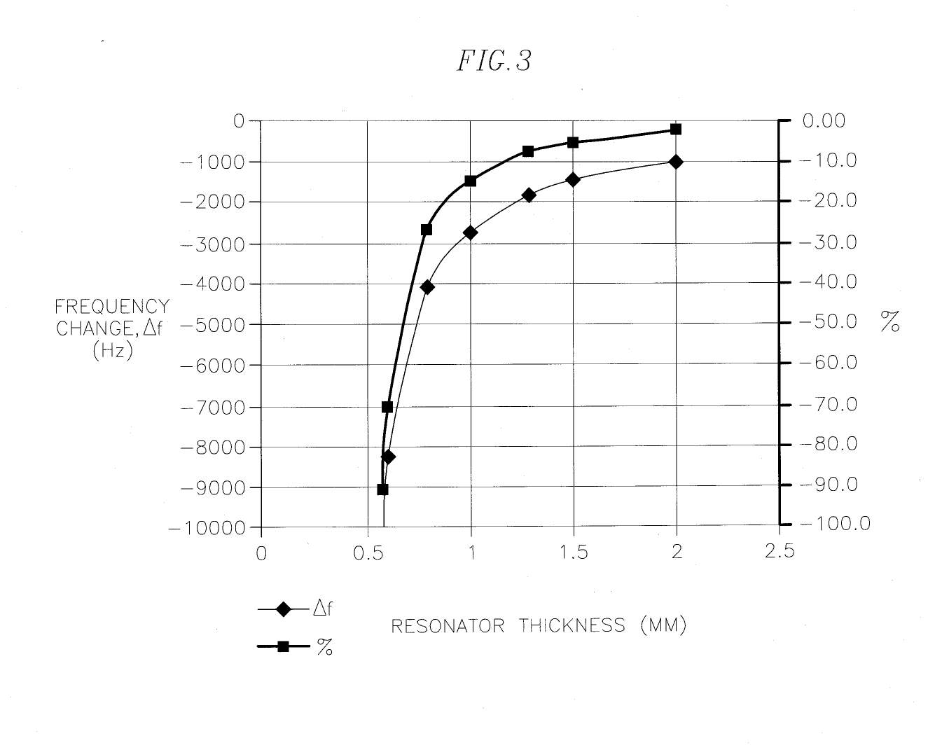

FIG. 3 is a graph illustrating the frequency change (shown for both the absolute frequency change and the percentage frequency change) of the resonance frequency of the resonator 103 according to one embodiment of the present disclosure as a function of the resonator 103 thickness when an external force of approximately 100 MPa is applied to the enclosure 101 compared to when no external force (i.e., unloaded, 0 MPa) is applied to the enclosure 101. As shown in FIG. 3, the resonance frequency change of the resonator 103 is a function of the thickness of the resonator 103. The table below shows the resonance frequency change for several different configurations of the resonator 103 when an external pressure (arrows 123) acts on the enclosure 101. For instance, as shown in the table below, for a resonator 103 having a total thickness of approximately 1 mm, including a diaphragm 107 having a thickness of approximately 0.5 mm and two piezoelectric layers 108, 110 each having a thickness of approximately 0.25 mm, the resonance frequency of the resonator 103 decreased by approximately 15% (i.e., the resonance frequency decreased by approximately −2,784 Hz) when an approximately 100 MPa external force was applied to the enclosure (i.e., the resonance frequency of the resonator 103 decreased from approximately 18,547 Hz when no external force was applied to the enclosure 101 to approximately 15,763 Hz when an external force of approximately 100 MPa was applied to the enclosure). Additionally, in one or more embodiments, the resonator 103 may be configured to achieve up to approximately 100% resonance frequency change when an external pressure or force is applied to the enclosure 101 of the pressure sensor 100. For instance, as shown in the table below, for a resonator 103 having a total thickness of approximately 0.58 mm, including a diaphragm 107 having a thickness of approximately 0.29 mm and two piezoelectric layers 108, 110 each having a thickness of approximately 0.145 mm, the resonance frequency of the resonator 103 decreased by approximately 91%.

| Total | PZT | | Resonance | Change of | % Change | |
|---|---|---|---|---|---|---|
| Thick- | Thick- | Resonance | Frequency | Resonance | of | |
| ness | ness | Frequency | at | Frequency | Resonance | |
| (mm) | (mm) | at 0 MPa | 100 MPa | ΔF (Hz) | Frequency | Z(Ω) |
| 2 | 0.5 | 30919 | 29973 | −946 | −3.1 | 38 |
| 1.5 | 0.375 | 25644 | 24178 | −1466 | −5.7 | 33 |
| 1.3 | 0.325 | 23042 | 21212 | −1830 | −7.9 | 32 |
| 1 | 0.25 | 18547 | 15763 | −2784 | −15.0 | 30 |
| 0.8 | 0.2 | 15231 | 11131 | −4100 | −26.9 | 30 |
| 0.6 | 0.15 | 11697 | 3435 | −8262 | −70.6 | 29 |
| 0.58 | 0.145 | 11317 | 1021 | −10296 | −91.0 | 29 |

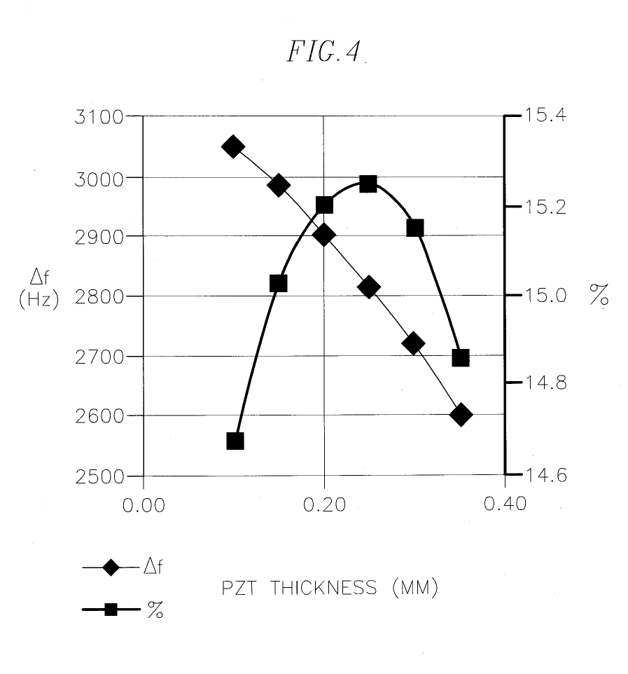

FIG. 4 is a graph illustrating the frequency change (shown for both the absolute frequency change and the percentage frequency change) of the resonance frequency of the resonator 103 as a function of the piezoelectric layer thickness when an external force of approximately 100 MPa is applied to the enclosure 101 compared to when no external force (i.e., 0 MPa) is applied to the enclosure 101. As illustrated in FIG. 4, in one or more embodiments, the maximum percentage change in resonance frequency occurs with a piezoelectric layer having a thickness of approximately 0.25 mm.

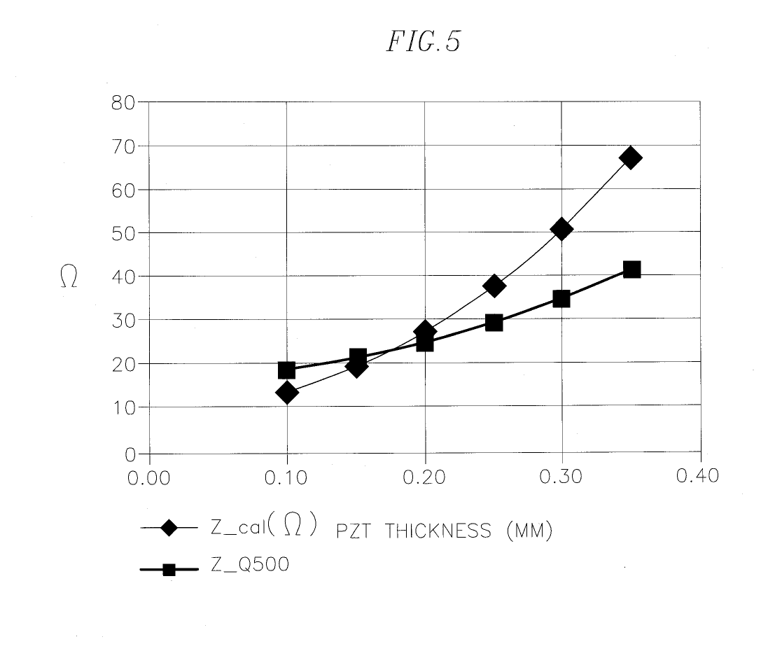

FIG. 5 is a graph illustrating the minimum electrical impedance (Ω) of the resonator 103 at resonance frequency as a function of the thickness of the piezoelectric layer when an external force of approximately 100 MPa is applied to the enclosure 101 of the pressure sensor 100. The impedance at resonance was calculated under the assumption that the quality factor (Q) of the titanium diaphragm 107, the piezoelectric layer, and the epoxy connecting base 104 and the cap 106 to the sidewall 105 are 1000, 500, and 10, respectively. FIG. 5 also depicts the minimum electrical impedance (Ω) of the resonator 103 as a function of the thickness of the piezoelectric layer when the resonator 103 has an overall quality factor (Q) of 500.

In one or more embodiments, the pressure sensor 100 may be configured to measure pressures up to approximately hundreds of megapascals (MPa). In one or more embodiments, the pressure sensor 100 may be configured to measure pressure in the range from approximately 20 MPa to approximately 200 MPa. In one or more embodiments, the resonator 103 of the pressure sensor 100 may be configured to operate in a frequency range from approximately 5 kHz to approximately 200 kHz. In one or more embodiments, resonator 103 may be configured to operate in a frequency range greater than approximately 200 kHz and/or less than approximately 5 kHz. In one or more embodiments, the resonator 103 of the pressure sensor 100 may have a high quality factor (Q). In one or more embodiments, the resonator 103 may have a Q of approximately 500 or more.

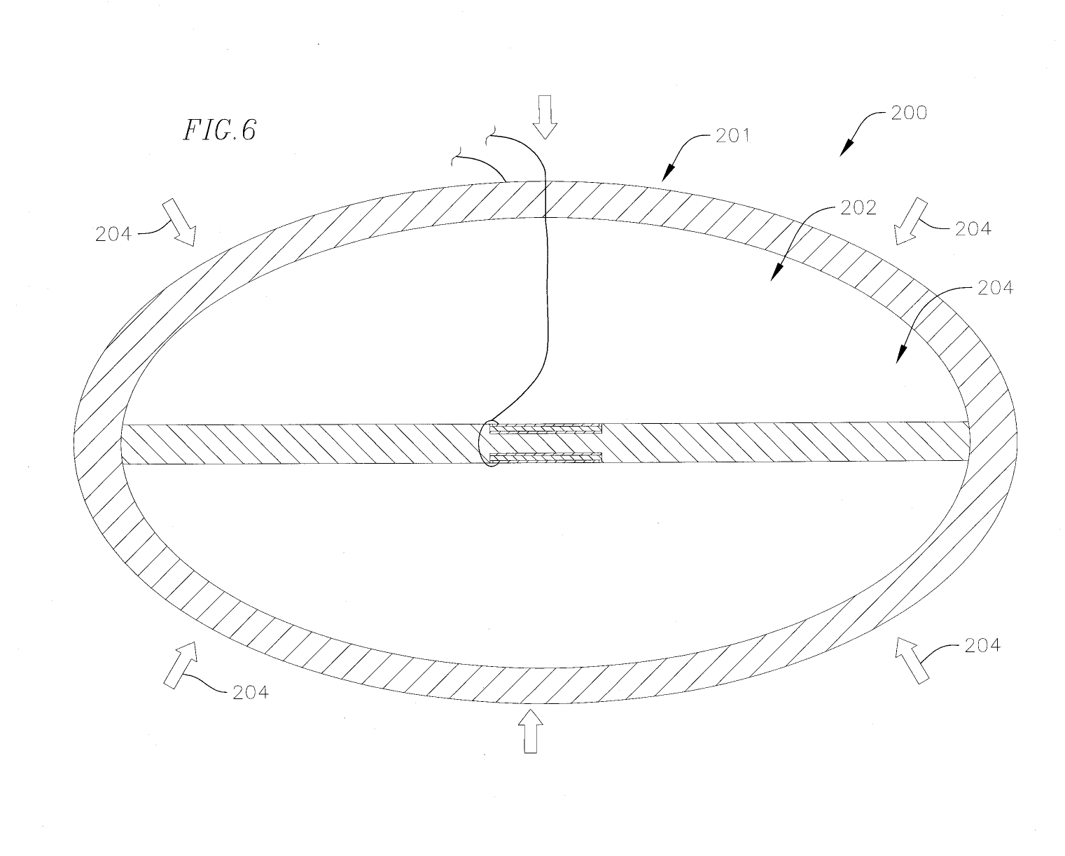

With reference now to FIG. 6, a pressure sensor 200 according to another embodiment of the present disclosure includes an enclosure 201 defining a sealed interior cavity or chamber 202 and a resonator 203 housed in the interior cavity 202 and connected to the enclosure 201. The resonator 203 may be the same or similar to the embodiment of the resonator 103 described above with reference to the embodiment of the pressure sensor 100 illustrated in FIGS. 1A-1B. Additionally, in the illustrated embodiment, the enclosure 201 is a flextensional enclosure. When an external pressure or force (arrows 204) is applied to the enclosure 201, the enclosure 201 is deformed, which induces tension on the resonator 203. The tension on the resonator 203 changes the resonance frequency of the resonator 203 and this change in resonance frequency may be used to determine the value of the external pressure or force (arrows 204) acting on the pressure sensor 200, in the same or similar manner as described above in more detail with reference to the embodiment of the pressure sensor 100 illustrated in FIGS. 1A-1B.

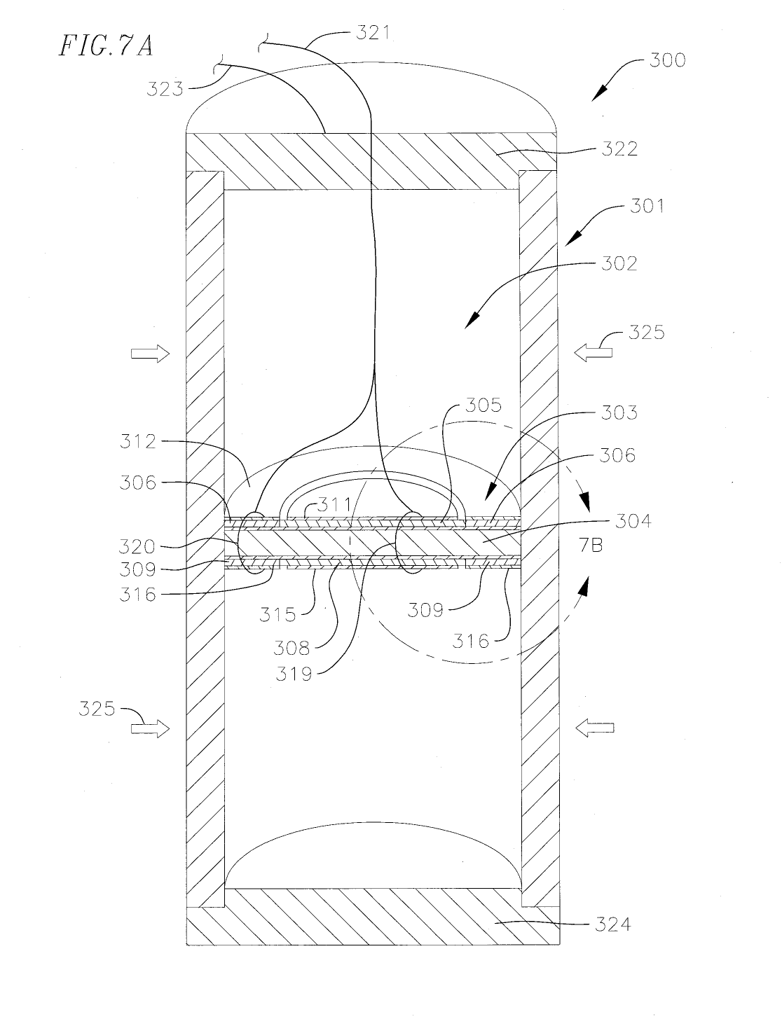

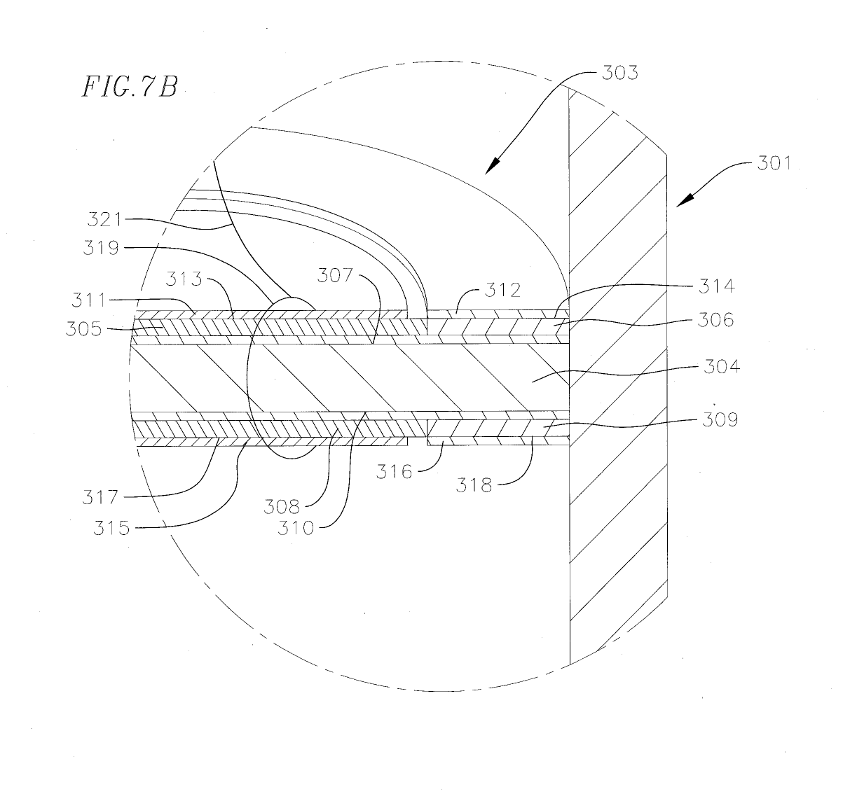

With reference now to FIGS. 7A-7B, a pressure sensor 300 according to another embodiment of the present disclosure includes an enclosure 301 defining a sealed interior cavity or chamber 302 and a resonator 303 housed in the interior cavity 302 and connected to the enclosure 301. The enclosure 301 may be the same or similar to the enclosure 101 described above with reference to the embodiment of the pressure sensor 100 illustrated in FIGS. 1A-1B or the same or similar to the enclosure 201 described above with reference to the embodiment of the pressure sensor 200 illustrated in FIG. 2.

In the illustrated embodiment, the resonator 303 includes a diaphragm 304 connected to the enclosure 301, two piezoelectric layers 305, 306 on a first surface 307 (e.g., an upper surface) of the diaphragm 304, two piezoelectric layers 308, 309 on a second surface 310 (e.g., a lower surface) of the diaphragm 304, two electrodes 311, 312 on outer surfaces 313, 314 of the two piezoelectric layers 305, 306, respectively, and two electrodes 315, 316 on outer surfaces 317, 318 of the two piezoelectric layers 308, 309, respectively. In the illustrated embodiment, the piezoelectric layers 305, 306, 308, 309 and the electrodes 311, 312, 315, 316 are each ring shaped. For instance, in one or more embodiments, the two electrodes 311, 312 on the outer surfaces 313, 314 of the two piezoelectric layers 305, 306 may be concentric rings, the two piezoelectric layers 305, 306 on the first surface 307 of the diaphragm 304 may be concentric rings, the two piezoelectric layers 308, 309 on the second surface 310 of the diaphragm 304 may be concentric rings, and/or the two electrodes 315, 316 on the outer surfaces 317, 318 of the two piezoelectric layers 308, 309 may be concentric rings. Accordingly, in one or more embodiments, the piezoelectric layers 305, 306, 308, 309 and/or the electrodes 311, 312, 315, 316 may be axisymmetric. Adjacent piezoelectric layers on the same side of the diaphragm 304 are poled in opposite directions. For instance, in the illustrated embodiment, the two piezoelectric layers 305, 306 on the first surface 307 of the diaphragm 304 are poled in opposite directions and the two piezoelectric layers 308, 309 on the second surface 310 of the diaphragm 304 are poled in opposite directions. Additionally, in the illustrated embodiment, one of the piezoelectric layers 305 on the first surface 307 of the diaphragm 304 is poled in the same direction as a corresponding one of the piezoelectric layers 308 on the second surface 310 of the diaphragm 304 and the other piezoelectric layer 306 on the first surface 307 of the diaphragm 304 is poled in the same direction as the corresponding piezoelectric layer 309 on the second surface 310 of the diaphragm 304. Although in one or more embodiments the two piezoelectric layers 305, 306 on the first surface 307 of the diaphragm 304 may be separate or distinct layers and/or the two piezoelectric layers 308, 309 on the second surface 310 of the diaphragm 304 may be separate or distinct layers, in one or more embodiments, the two piezoelectric layers 305, 306 on the first surface 307 of the diaphragm 304 may be different portions of the same piezoelectric layer and/or the two piezoelectric layers 308, 309 on the second surface 310 of the diaphragm 304 may be different portions of the same piezoelectric layer (e.g., the two piezoelectric layers 305, 306 and/or the two piezoelectric layers 308, 309 may refer to differently poled portions of the same piezoelectric layer).

Additionally, the electrode 311 on the piezoelectric layer 305 is electrically connected to the electrode 315 on the piezoelectric layer 308 by a first electrical line 319 and the electrode 312 on the piezoelectric layer 306 is electrically connected to the electrode 316 on the piezoelectric layer 309 by a second electrical line 320. Although in the illustrated embodiment the resonator 303 includes two electrodes 311, 312 and 315, 316 on each side of the diaphragm 304, in one or more embodiments, the resonator 303 may include any other suitable number of electrodes on each side of the diaphragm 304, such as, for instance, three or more electrodes. Accordingly, the resonator 303 may include a series of patterned electrodes on the piezoelectric layers on the upper and/or the lower surfaces of the diaphragm 304.

In the illustrated embodiment, the pressure sensor 300 also includes a first electrical terminal 321 coupled to the electrical lines 319, 320 that couple the electrodes 311, 312 on the piezoelectric layers 305, 306 to the electrodes 315, 316 on the piezoelectric layers 308, 309, respectively. In the illustrated embodiment, the first electrical terminal 321 extends up and out of the sealed interior cavity 302 through a cap 322 of the enclosure 301 (e.g., through a feedthrough on the cap 322). In the illustrated embodiment, the pressure sensor 300 also includes a second electrical terminal 323 coupled to the enclosure 301 (e.g., the cap 322 or a base 324 of the enclosure 301). The second electrical terminal 323 is configured to function as a grounding terminal for grounding the enclosure 301.

When an external pressure or force (arrows 325) is applied to the enclosure 301, the enclosure 301 is deformed, which induces tension or compression on the resonator 303 depending on the configuration of the resonator 303 and/or the enclosure 301. The tension or compression on the resonator 303 changes the resonance frequency of the resonator 303 and this change in resonance frequency may be used to determine the value of the external pressure or force acting on the pressure sensor 300, in the same or similar manner as described above in more detail with reference to the embodiment of the pressure sensor 100 illustrated in FIGS. 1A-1B.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Although relative terms such as “outer,” “inner,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “generally,” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween. Further, any described feature is optional and may be used in combination with one or more other features to achieve one or more benefits.

What is claimed is:

1. A pressure sensor, comprising:
an enclosure defining an interior cavity;
a bending resonator housed in the interior cavity, the bending resonator comprising:
a diaphragm connected to the enclosure, the diaphragm comprising a first surface and a second surface opposite the first surface;
at least one piezoelectric layer on one of the first surface or the second surface of the diaphragm; and
at least one electrode on the at least one piezoelectric layer; and
at least one electrical terminal coupled to the at least one piezoelectric layer and extending out through the enclosure, the at least one electrical terminal configured to apply an input signal to the at least one piezoelectric layer to resonate the bending resonator,
wherein a resonance frequency of the bending resonator changes according to a change in an external pressure applied to the pressure sensor, and
wherein the resonance frequency of the bending resonator corresponds to the external pressure applied to the pressure sensor.

2. The pressure sensor of claim 1, wherein the enclosure is configured to deform when the external pressure is applied to the pressure sensor.

3. The pressure sensor of claim 2, wherein deformation of the enclosure applies tension to the bending resonator to change the resonance frequency of the bending resonator.

4. The pressure sensor of claim 2, wherein deformation of the enclosure applies compression to the bending resonator to change the resonance frequency of the bending resonator.

5. The pressure sensor of claim 1, wherein the at least one piezoelectric layer comprises a first piezoelectric layer on the first surface of the diaphragm and a second piezoelectric layer on the second surface of the diaphragm, and wherein the first piezoelectric layer is coupled to the second piezoelectric layer.

6. The pressure sensor of claim 5, wherein the first piezoelectric layer is coupled to the second piezoelectric layer in parallel.

7. The pressure sensor of claim 5, wherein the first piezoelectric layer is coupled to the second piezoelectric layer in series.

8. The pressure sensor of claim 1, wherein the at least one piezoelectric layer comprises a plurality of piezoelectric layers on at least one of the first surface or the second surface of the diaphragm.

9. The pressure sensor of claim 1, wherein the at least one piezoelectric layer comprises a plurality of stacked piezoelectric layers.

10. The pressure sensor of claim 1, wherein the at least one electrode comprises a plurality of electrodes patterned on the at least one piezoelectric layer.

11. The pressure sensor of claim 1, wherein the enclosure has a shape selected from the group of shapes consisting of a cylindrical shape, a spherical shape, and a prismatic shape.

12. The pressure sensor of claim 1, wherein the enclosure is a flextensional enclosure.

13. The pressure sensor of claim 1, wherein the enclosure comprises:
at least one sidewall;
a base connected to a first end of the at least one sidewall; and
a cap connected to a second end of the at least one sidewall opposite the first end.

14. The pressure sensor of claim 1, wherein the bending resonator has a shape selected from the group of shapes consisting of a circular shape, a square shape, a ring shape, and a rectangular shape.

15. The pressure sensor of claim 1, wherein a thickness of the bending resonator is uniform.

16. The pressure sensor of claim 1, wherein a thickness of the bending resonator is non-uniform.

17. The pressure sensor of claim 1, wherein the at least one piezoelectric layer comprises a material selected from the group of polarized materials consisting of a piezoceramic material, an electrostrictive material, and a piezoelectric crystal.

18. A method of measuring pressure, comprising:
positioning a pressure sensor in an environment exhibiting the pressure to be measured, the pressure sensor comprising:
an enclosure defining an interior cavity;
a bending resonator housed in the interior cavity, the bending resonator comprising:
a diaphragm connected to the enclosure, the diaphragm comprising a first surface and a second surface opposite the first surface;
at least one piezoelectric layer on one of the first surface or the second surface of the diaphragm; and
at least one electrode on the at least one piezoelectric layer; and
at least one electrical terminal coupled to the at least one piezoelectric layer and extending out through the enclosure,
wherein a resonance frequency of the bending resonator changes according to a change in the pressure of the environment,
wherein the resonance frequency of the bending resonator corresponds to the pressure of the environment;
applying an input signal to the at least one piezoelectric layer to resonate the bending resonator;
determining the resonance frequency of the bending resonator; and
determining the pressure of the environment by referencing the resonance frequency of the bending resonator.

19. The method of claim 18, wherein the pressure of the environment deforms the enclosure, and wherein deformation of the enclosure applies tension or compression on the bending resonator and varies the resonance frequency of the bending resonator.

20. The method of claim 18, further comprising reading the resonance frequency of the bending resonator through an electromagnetic waveguide.
